(19) United States
(12) Patent Application Publication
(10) Pub. No.: US 2026/0319078 A1
(43) Pub. Date: Oct. 15, 2026

(54) METHOD FOR INSTALLING AN ULTRASONIC SENSOR ON A BODY COMPONENT IN A COVERED MANNER

(71) Applicant: Valeo Schalter und Sensoren GmbH, Bietigheim-Bissingen (DE)

(72) Inventors: Heinrich Gotzig, Bietigheim-Bissingen (DE); Paul-David Rostocki, Bietigheim-Bissingen (DE); Thomas Jung, Bietigheim-Bissingen (DE); Uwe Kupfernagel, Bietigheim-Bissingen (DE); Sebastian Neft, Bietigheim-Bissingen (DE); Christian Behtan, Bietigheim-Bissingen (DE)

(73) Assignee: Valeo Schalter und Sensoren GmbH, Bietigheim-Bissingen (DE)

(21) Appl. No.: 19/479,102

(22) PCT Filed: Apr. 11, 2024
(86) PCT No.: PCT/EP2024/059780

§ 371 Date: Oct. 27, 2025

(30) Foreign Application Priority Data
Apr. 27, 2023 (DE) 10 2023 110 886.7

(51) Int. Cl. G01S 7/521; G01S 15/931

(52) U.S. Cl. CPC G01S 7/521; G01S 15/931; G01S 2015/937

(57) ABSTRACT

Described is a method for installing an ultrasonic sensor on a body component in a covered manner. A damping material with an opening is arranged on the inner face of the body component. The ultrasonic sensor is pre-installed such that an ultrasonic diaphragm of the ultrasonic sensor comes into contact with the inner face of the body component in a planar manner within the opening of the damping material. A suction bell is placed on the body component together with the damping material and the pre-installed ultrasonic sensor such that the outer circumferential wall of the suction bell rests on the damping material. An inner support element of the suction bell rests on the ultrasonic sensor. A negative pressure is generated in the suction bell, where the suction bell is secured to the body component by suction and the inner support element presses the ultrasonic sensor against the body component.

The present invention relates to the field of motor vehicle ultrasonic sensors and more specifically to a method for the concealed mounting of an ultrasonic sensor on a body component.

Motor vehicles are equipped with ultrasonic sensors which are used to survey the surroundings of the motor vehicle by means of transmitted and received reflected ultrasonic signals and, by using the measured information about possible reflection locations of the ultrasonic signals in the surroundings of the motor vehicle which represent possible obstacles, to provide assistance functionality such as partially or fully autonomous parking, a blind spot assistance function, a door opening assistance function and the like. The ultrasonic sensors can be mounted openly or concealed. In the case of an open mounting, an ultrasonic diaphragm of the ultrasonic sensor is exposed in an opening in a body component. In the case of a concealed mounting, the ultrasonic diaphragm is coupled to the body component, and a portion of the body component that is coupled to the ultrasonic diaphragm vibrates jointly with the ultrasonic diaphragm. The concealed mounting is preferred for esthetic reasons but also for the improved protection of the ultrasonic sensor against environmental influences.

In the case of a concealed mounting of an ultrasonic sensor, it is important that the ultrasonic diaphragm rests flush without any bubbles on the body component; otherwise, malfunctions of the ultrasonic sensor mounted in a concealed manner can be expected.

In the case of the concealed mounting of an ultrasonic sensor on the inner side of a metallic body component, such as a vehicle door or a fender, bulges and air bubbles between the ultrasonic diaphragm and the body part can easily arise. In order to achieve the necessary freedom from bubbles, the sensor can be pressed against the metal component by hand or with a tool. However, here there is the risk that a dent is produced in the metal component if forces of more than 5 kg (50 N) are exerted. If higher forces are to be exerted, a suitable counter-force must be provided, which complicates the mounting and carries the risk of esthetic damage to the outside of the body component. In addition, in such a type of mounting, there is no certainty as to whether the necessary force has been exerted long enough to achieve freedom from bubbles, so that rejects inevitably occur.

Against this background, the present invention is based on the object of improving the process of the concealed mounting of ultrasonic sensors on body components.

Accordingly, a method for the concealed mounting of an ultrasonic sensor on a body component is proposed, which comprises: arranging a damping material having an opening on an inner side of the body component; pre-assembling the ultrasonic sensor in such a way that an end face of a diaphragm well of the ultrasonic sensor comes into flat contact with the inside of the body component within the opening in the damping material; placing a suction cup on the body component with the damping material arranged thereon and the preassembled ultrasonic sensor in such a way that an outer circumferential wall of the suction cup rests on the damping material and an internal support element of the suction cup rests on the ultrasonic sensor; and producing a negative pressure in the suction cup, as a result of which the suction cup is sucked firmly against the body component and the internal support element presses the ultrasonic sensor against the body component.

As a result of the fact that negative pressure prevails and the ultrasonic sensor is pressed against the body component, it is advantageously ensured that the ultrasonic diaphragm rests on the inner side of the body component without any bubbles.

The production of a negative pressure can also be designated as the production of a vacuum, wherein a vacuum does not need to designate an absolute vacuum, instead a relative vacuum is sufficient as long as a negative pressure with respect to an atmospheric pressure prevailing outside the suction cup prevails within the suction cup.

In particular, the vacuum can advantageously draw out any air bubbles between the diaphragm surface and the body component. In addition, by means of the negative pressure, a considerably higher contact force than 50 N can be exerted in a controlled and uniform manner without any fear of damage. As a result, flush, bubble-free coupling between a surface of the ultrasonic diaphragm and an inner surface of the body component can advantageously be achieved.

As a result of the improved bubble-free coupling between the ultrasonic diaphragm and the body component, the result is advantageously improved operating properties of the measuring system which is formed by the ultrasonic sensor and the portion of the body component that is coupled thereto, and the measuring system is able to supply more exact, lower-error measured data.

In addition, a reject rate during the production of subassemblies comprising body components with ultrasonic sensors mounted concealed on the inner side can advantageously be reduced.

In particular, it goes without saying that following the pressing of the ultrasonic sensor against the body component, the ultrasonic cup is brought to normal pressure again and can be removed. Accordingly, a subassembly produced in accordance with the proposed method can in particular comprise the body component, the damping material attached thereto, the ultrasonic sensor finally mounted in particular as a result of the action of the vacuum, but not the suction cup, which is a tool for the final mounting.

The body component can be, for example, a door for a motor vehicle, a side sill for a motor vehicle, a fender for a motor vehicle or any other body component.

Arranging the damping material can comprise attaching the damping material to the inner side of the body component by adhesive bonding or the like. Arranging the damping material can also comprise primary forming of the damping material on the inner side of the body component, for example by applying a paste and subsequently curing it or the like. The damping material can comprise butyl, purely by way of example. The damping material in particular has the advantageous function, during the operation of the ultrasonic sensor, of damping the vibrations of that non-damped portion of the body component which is coupled to the ultrasonic diaphragm with respect to other portions of the body component, so that the subassembly comprising the non-damped body component portion and the ultrasonic diaphragm coupled thereto can exhibit clearly defined vibration modes and natural frequencies. The opening can be arranged centrally in the damping material.

The preassembly of the ultrasonic sensor can comprise holding the ultrasonic sensor with a holding tool in the position required for the pressing that is carried out in the following steps. It is also conceivable to use a holding element which, for example, is attached to the body component or the damping material and in which the ultrasonic sensor is fitted and preassembled as a result.

According to one embodiment, an adhesive and sound-conducting contact pad is arranged on the ultrasonic diaphragm of the ultrasonic sensor and, in the preassembled ultrasonic sensor, is in flat contact with the inner side of the body component.

The adhesive and sound-conducting contact pad can advantageously ensure permanent bubble-free acoustic coupling of the ultrasonic diaphragm to the inner side of the body component.

According to a further embodiment, when vacuum is produced, a pressure of 150 N or more, preferably of 200 N or more, especially preferably 250 N or more, is exerted on the ultrasonic sensor.

Accordingly, a stable bubble-free coupling between the ultrasonic diaphragm and the inner surface of the body component can be produced, with a particularly high degree of certainty and a reject rate can be reduced further.

In particular, with the proposed method, forces in the aforementioned range can advantageously be exerted without risking damage to the body component or to the ultrasonic sensor.

According to a further embodiment, the suction cup has a cylinder that is movable in the axial direction which, when the suction cup is put in place, is aligned coaxially with the ultrasonic diaphragm of the ultrasonic sensor and of which the end face facing the ultrasonic sensor forms the internal support element of the suction cup, which rests on an end face of the ultrasonic sensor that is axially opposite the ultrasonic diaphragm.

Accordingly, at the given negative pressure, the force which is exerted on the ultrasonic sensor during the pressing can be defined clearly; in particular the desired force can be monitored and selected suitably by adapting the diameter of the movable cylinder.

In particular, the suction cup can have an axial hollow cylindrical opening, into which the movable cylinder is inserted and against which the movable cylinder closes in an airtight manner.

According to a further embodiment, the outer circumferential wall of the suction cup has a door and, when the door is opened, the suction cup is slid over the damping material and the preassembled ultrasonic sensor from the side and then the door is closed.

This means that the suction cup, together with the damping material arranged thereon and the preassembled ultrasonic sensor, can be placed on the body component by the suction cup being pushed over the damping material and the ultrasonic sensor from the side.

Accordingly, the space required for the placement of the suction cup on the assembly comprising body component, damping material and preassembled ultrasonic sensor is reduced, and the ultrasonic sensor can be mounted, for example, even when space is restricted, for example in particular even when the body component is already installed in a vehicle.

The door can be a sliding door, for example.

According to a further embodiment, the preassembly of the ultrasonic sensor comprises: attaching a holding element for the ultrasonic sensor to the damping material and inserting the ultrasonic sensor into the holding element in such a way that the ultrasonic diaphragm comes into flat contact with an inner side of the body component within the opening of the damping material.

The holding element is in particular an element which, following the mounting of the ultrasonic sensor, remains in the subassembly produced in such a way and comprising a body component, damping material, holding element and ultrasonic sensor.

The holding element advantageously permits simple preassembly of the ultrasonic sensor and in addition permits simple subsequent replacement of the ultrasonic sensor, for example in the event of a defect. For this purpose, the defective ultrasonic sensor can be removed from the holding element and a new ultrasonic sensor can be inserted into the holding element and thus the suction cup can be used to couple the new ultrasonic sensor to the body component again without bubbles.

According to a further embodiment, the suction cup has a further internal support element which, when the suction cup is put in place, rests on the holding element and presses on the holding element when vacuum is produced.

Accordingly, in embodiments which use the holding element, a separate operation for pressing the holding element onto the damping material, for example rolling, is advantageously saved and the holding element can be pressed against the damping material and the body element together with the ultrasonic sensor in a single operation.

According to a further embodiment, the further internal support element is formed from a plurality of pillars, which rest on the holding element at a plurality of points, or the further internal support element is formed by a plunger which rests on the entire area of the holding element.

“Rests on the entire area” is to be understood to mean that the plunger covers a surface of the holding element extending parallel to the body component, such as a flange section of the holding element, not just at a point but over an area, in particular by more than 50%, preferably by more than 75%. However, it is not necessary that the surface of the holding element that extends parallel to the body component is covered completely.

By using a plunger resting on the entire area, a more uniform pressure can advantageously be exerted on the holding element than by using a plurality of pillars resting on points. By contrast, the plurality of pillars offer the advantage that more space remains within the suction cup and the placement of the suction cup on the subassembly comprising body component, damping material, holding element and ultrasonic sensor is simplified.

According to a further embodiment, the ultrasonic sensor has a cylindrical housing component and a cylindrical diaphragm well inserted into an opening in the end face of the cylindrical housing component, the end face of which diaphragm well forms the ultrasonic diaphragm; the holding element has a first hollow cylindrical portion, of which the inner contour corresponds to an outer contour of the cylindrical housing component, has a second hollow cylindrical portion, the inner contour of which corresponds to an outer contour of the cylindrical diaphragm well and the outer contour of which corresponds to an inner contour of the opening, and has a flange section; the holding element is attached to the damping material in such a way that the flange section rests on the damping material and the second hollow cylindrical portion is inserted into the opening in the damping material; and the ultrasonic sensor is inserted into the holding element in such a way that the diaphragm well rests flush on the second hollow cylindrical portion of the holding element and the cylindrical housing section rests flush on the first hollow cylindrical portion of the holding element.

Accordingly, the ultrasonic sensor is advantageously firmly seated in the holding element without any gaps, and the holding element is preferably firmly seated in the opening in the sealing material without any gaps.

The first hollow cylindrical portion, the second hollow cylindrical portion and the flange portion can be formed in a single piece, in particular integrally.

According to a development, within the context of the preassembly, following the insertion of the ultrasonic sensor into the holding element, a retaining clip can be placed on the subassembly comprising the holding element and ultrasonic sensor, which holds the ultrasonic sensor in the holding element.

The retaining clip can have an opening through which, in the subsequent mounting step, the internal support element of the suction cup presses on the ultrasonic sensor under the action of the negative pressure. As an alternative, in the mounting step the internal support element of the suction cup can press on the retaining clip and, via the retaining clip, on the ultrasonic sensor.

According to a further aspect, a motor vehicle having a body component is proposed, on which an ultrasonic sensor is mounted in a concealed manner according to the proposed method.

The embodiments and features described for the proposed method apply accordingly to the proposed motor vehicle.

Further possible implementations of the invention also comprise not explicitly mentioned combinations of features or embodiments described above or below with regard to the exemplary embodiments. A person skilled in the art will also add individual aspects as improvements or additions to the respective basic form of the invention.

Further advantageous configurations and aspects of the invention are the subject matter of the dependent claims and of the exemplary embodiments of the invention that are described below. The invention is explained in more detail below on the basis of preferred embodiments with reference to the accompanying figures.

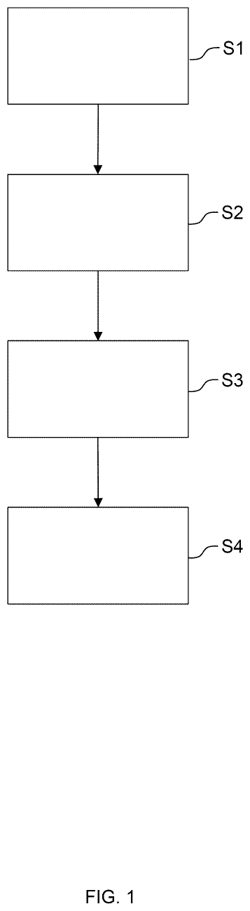

FIG. 1 illustrates steps of a proposed production method according to exemplary embodiments;

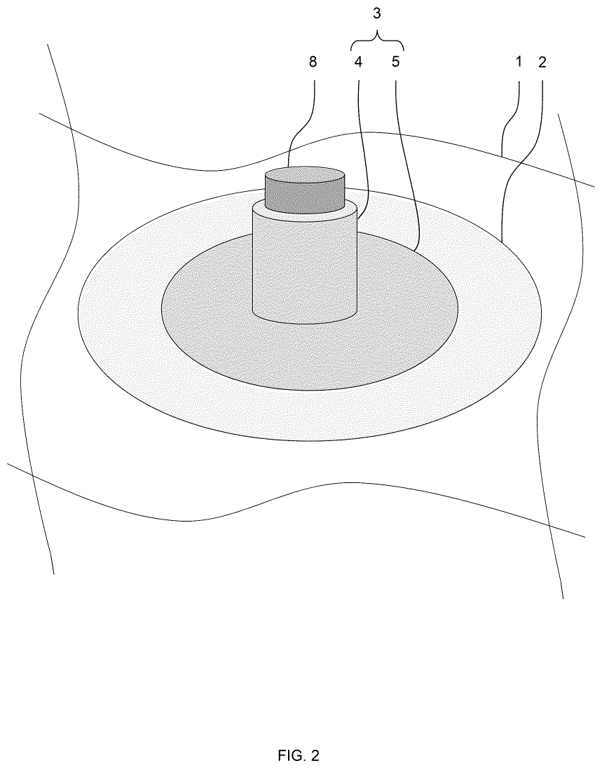

FIG. 2 shows a subassembly comprising the body component, damping material, holding element and preassembled ultrasonic sensor according to exemplary embodiments;

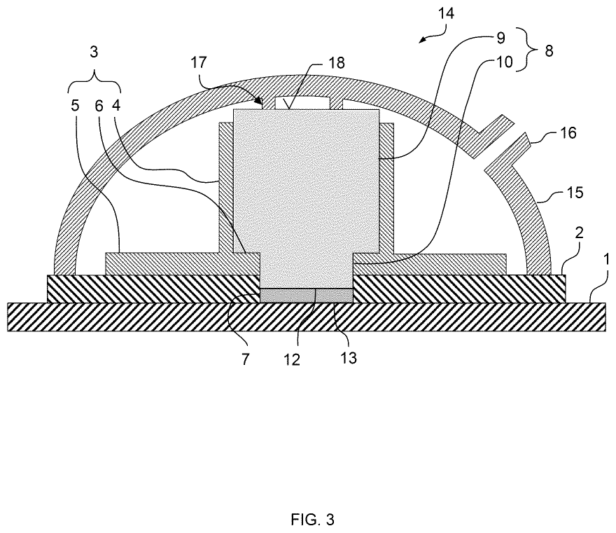

FIG. 3 shows a sectional view of a suction cup according to a first exemplary embodiment placed on the subassembly from FIG. 2;

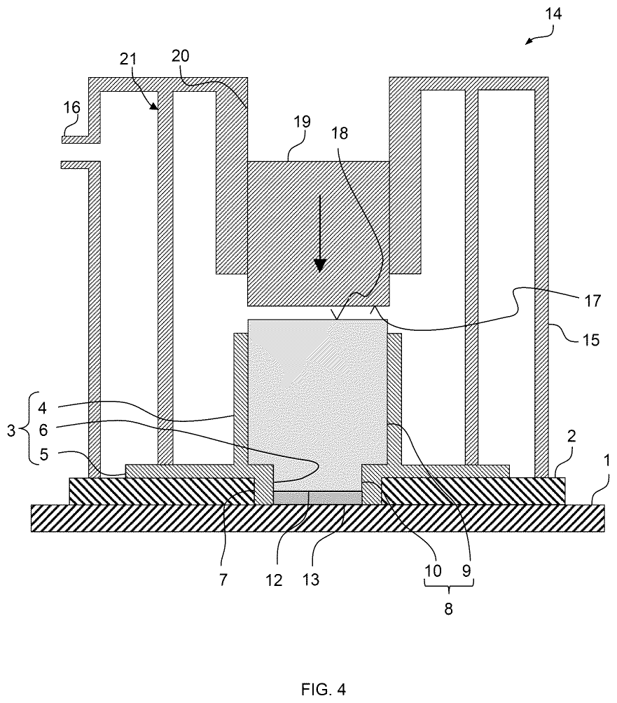

FIG. 4 shows a sectional view of a suction cup according to a second exemplary embodiment placed on the subassembly from FIG. 2;

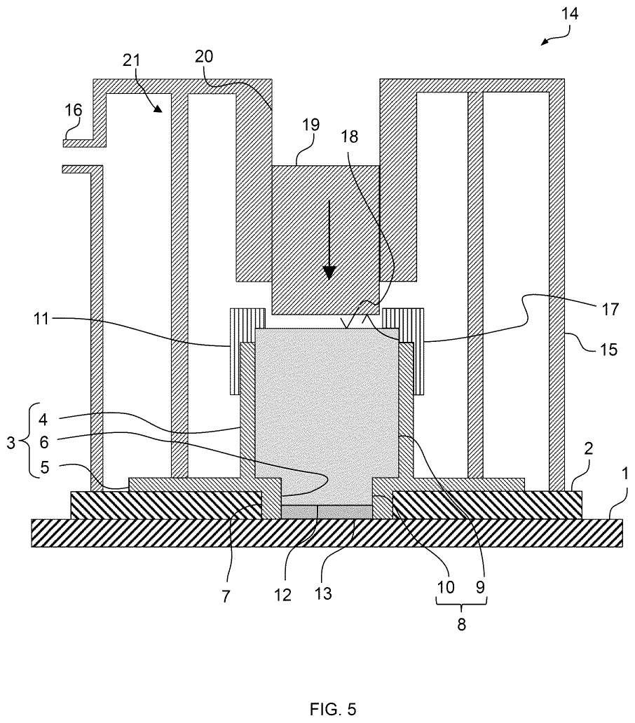

FIG. 5 shows a sectional view of a suction cup according to a development of the second exemplary embodiment, placed on the subassembly from FIG. 2;

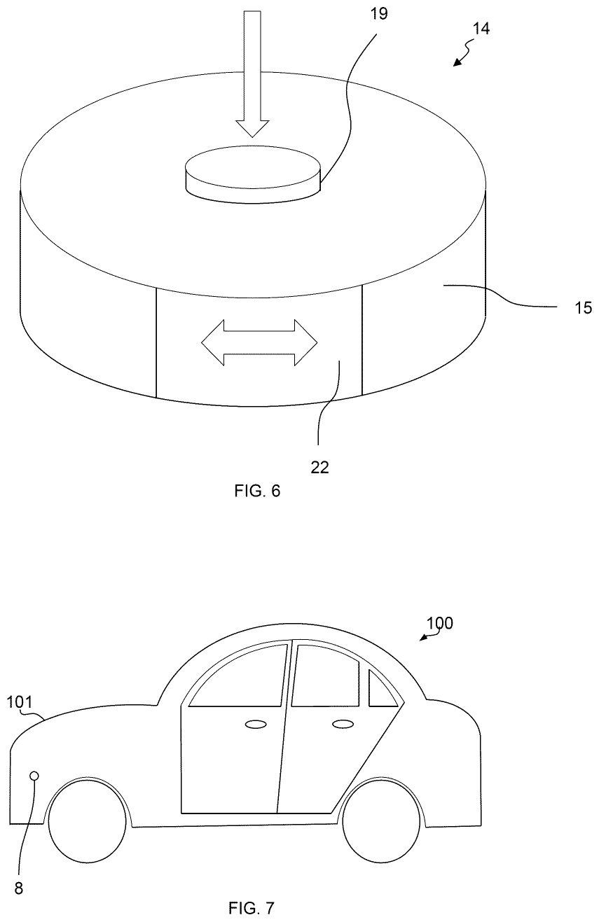

FIG. 6 shows a suction cup according to a further development of the second exemplary embodiment; and

FIG. 7 shows a motor vehicle having an ultrasonic sensor mounted in a concealed manner.

Identical or functionally identical elements are denoted by the same reference signs in the figures, unless stated otherwise.

FIG. 1 illustrates steps of a proposed production method according to exemplary embodiments. FIG. 2 shows a subassembly comprising body component, damping material, holding element and preassembled ultrasonic sensor according to exemplary embodiments. FIG. 3 shows a sectional view of a suction cup according to a first exemplary embodiment placed on the subassembly from FIG. 2. Reference is made to FIG. 1 to FIG. 3.

The body component 1 is a sheet-like body component such as, for example, a metal door sheet or a fender of a motor vehicle, such as an automobile. In step S1 of the proposed method, a damping material 2 is arranged in a substantially circular area of the body component 1. The damping material 2 can be butyl, for example, which adheres to the body component by adhesion. The damping material 2 has a substantially circular central opening 7 (FIG. 3).

Then, in step S2, a holding element 3 having a first hollow cylindrical portion 4, a flange portion 5 and a second hollow cylindrical portion 6 (FIG. 3) is attached to the damping material 2. In particular, the holding element 3 can be adhesively bonded to the damping material and a firm connection of the holding element 3 to the damping material 2 can be produced by means of rolling the flange section 5. It should be pointed out that, according to the first exemplary embodiment, the holding element 3 is arranged in such a way that an inner circumference of the second hollow cynical portion 6 is aligned flush on an inner circumference of the central opening 7 of the damping material 2.

Furthermore, in step S2, an ultrasonic sensor 8 is inserted into the holding element 3. The ultrasonic sensor 8 has a cylindrical housing component 9 and a membrane well 10 inserted into an opening in the end face of the cylindrical housing component 9. An inner contour of the first hollow cylindrical portion 4 of the holding element 3 corresponds to an outer contour of the cylindrical housing component 9 of the ultrasonic sensor 8, so that these rest flush on each other.

An adhesive and sound-conducting contact pad 13 is attached, for example adhesively bonded, to an end face 12 of the diaphragm well 10 of the ultrasonic sensor 8 which forms an ultrasonic diaphragm 12 of the ultrasonic sensor 8.

With the insertion of the ultrasonic sensor 8 configured in this way into the holding element 3, a process of the preassembly of the ultrasonic sensor 8 is completed. The ultrasonic diaphragm 12 of the ultrasonic sensor 8 is held in flat contact with the inner side of the body component 1 within the central opening 7 of the damping material, and the cylindrical housing portion 9 of the ultrasonic sensor 9 is held in the first hollow cylindrical portion 4 of the holding element 3.

In this preassembled state, the ultrasonic diaphragm 12, the contact pad 13 and a portion of the body component 1 contacted by the latter and not covered by the damping material 2 form a vibratory diaphragm, which can be set vibrating, for example by a piezoelectric element, not shown, which can be attached to an inner side of the ultrasonic diaphragm 12, in order to transmit ultrasonic waves or can receive incoming ultrasonic waves and be set vibrating by the latter, by which means the incoming ultrasonic waves can be registered by the piezoelectric element. The damping material 2 ensures that vibrations of the portion of the body component 1 that is contacted by the contact pad 13 do not propagate into further portions of the body component 1, and therefore ensures defined natural frequencies and vibration modes of the vibratory diaphragm.

However, in the preassembled state, there can still be air bubbles between the ultrasonic diaphragm 12 and the contact pad 13 and/or between the contact pad 13 and the inner side of the body component 1, which can impair the operating properties of the ultrasonic sensor 8 and the vibratory diaphragm.

Accordingly, in step S3, a suction cup 14 is placed on the subassembly, shown in FIG. 2 and FIG. 3, comprising the body component 1 with the damping material 2 arranged thereon and the preassembled ultrasonic sensor 8, in such a way that an outer circumferential wall 15 of the suction cup 14 rests on the damping material 2 and a plurality of internal support elements 17 of the suction cup 14 rest on the ultrasonic sensor 8. In particular, the support elements 17 are located on an end face 18 of the ultrasonic sensor 8 that is axially opposite the ultrasonic diaphragm 12.

The suction cup 14 also has a suction nozzle 16, which is connected to a vacuum pump (not shown) via a hose (not shown).

In step S4, by pumping the air away out of an interior of the suction cup 14 through the suction nozzle 16 and the hose by using the vacuum pump, a negative pressure (for example a vacuum) is produced in the suction cup 14.

As a result, the suction cup is sucked firmly against the body component 1, the vacuum sucks away any air bubbles between the ultrasonic sensor 8 and the body component 1, and the internal support elements 17 of the suction cup press the ultrasonic sensor 18 against the body component 1.

Thus, a firm, bubble-free coupling between the ultrasonic diaphragm 12, contact pad 13 and body component 1 can advantageously be produced.

Here, the compressive force to be exerted can be monitored by regulating the negative pressure or the pumping power of the vacuum pump, and the compressive force to be exerted is exerted uniformly over the entire ultrasonic sensor 8.

Advantageously, by producing a suitable negative pressure or vacuum in the suction cup 14, a compressive force of 150 N, 200 N, 250 N or more can be achieved without deformation of the body component 1 occurring.

It should be noted that, preferably, the first hollow cylindrical portion 4 and the second hollow cylindrical portion 6 of the holding element 3 are not formed annularly around the entire circumference of the cylindrical housing component 9 or the diaphragm well 10 but, in at least one section plane not shown in FIG. 3, have at least one slit extending vertically, so that the slit allows a passage of air between the interior of the suction cup 14 and the diaphragm well 10, the contact pad 19 and the body component 1 within the hollow cylindrical portions 4 and 6. In this way, the vacuum produced in the interior of the suction cup 14 can suck away air bubbles between the diaphragm well 10, contact pad 19 and body component 1.

FIG. 4 shows a sectional view of a suction cup according to a second exemplary embodiment placed on the subassembly from FIG. 2. The following description concentrates on the differences between the second exemplary embodiment and the first exemplary embodiment. If appropriate, the same or functionally identical elements and/or steps are not described again. Reference is made to FIG. 4 and FIG. 1.

According to the second exemplary embodiment, configurations of the holding element 3 and of the suction cup 14 differ from those of the corresponding elements according to the first exemplary embodiment. Firstly, the suction cup 14 of the second exemplary embodiment will be described.

The suction cup 14 has an axial hollow cylindrical opening 20, into which a movable cylinder 19 is inserted. An end face 17 of the movable cylinder 19 facing the ultrasonic sensor 8 forms an internal support element 17 of the suction cup 14. If the air is sucked away from the interior of the suction cup 14 through the suction nozzle 16 by the vacuum pump (not shown), the movable cylinder 19 is drawn downward in FIG. 4 and presses on the end face 18 of the ultrasonic sensor 8.

Accordingly, the pressure which is exerted on the ultrasonic sensor 8 in step S4 is advantageously distributed uniformly over the entire end face 18 of the ultrasonic sensor 8.

In addition, the force which is exerted when pressing on the ultrasonic sensor 8 can advantageously be regulated more accurately. This force depends on the diameter of the movable cylinder 19. Thus, with a given pumping power of the vacuum pump, the desired compressive force can be defined clearly by choosing a suitable diameter of the movable cylinder 19.

The suction cup 14 additionally has further internal support elements 21, which are formed as respective pillars 21, which rest on the flank section 5 of the holding element 3 at a plurality of points. Accordingly, in step S4, as the air is pumped away out of the suction cup 14, not only is the cylinder 19 pressed against the ultrasonic sensor 8 but the suction cup 14 additionally also presses on the holding element 8 via the pillars 21. According to the second exemplary embodiment, in step S2 an operation of pressing or rolling on the holding element 3 onto the sealing material 2 can therefore advantageously be omitted, and the adhesive connection of the holding element 3 to the sealing material 2 can be produced in the same operation in which the ultrasonic diaphragm 12 is coupled to the body component 1, specifically by producing the negative pressure in the interior of the suction cup 14.

The holding element 3 of the second exemplary embodiment differs from the holding element 3 of the first exemplary embodiment in that the second hollow cylindrical portion 6 of the holding element 3 of the second exemplary embodiment is not arranged flush with the central opening 7 in the damping material, instead the second hollow cylindrical portion 6 is inserted into the central opening 7 in the damping material 2. An outer contour of the second hollow cylindrical portion 6 corresponds to an inner contour of the central opening 7, so that these rest flush on each other. An inner contour of the second hollow cylindrical portion 6 corresponds to an outer contour of the cylindrical diaphragm well 10 of the ultrasonic sensor 8, so that these rest flush on each other. A still firmer seat of the ultrasonic sensor 8 in the holding element 3 can thus advantageously be ensured, since the diaphragm well 10 of the ultrasonic sensor 8 is then also held better in the second hollow cylindrical portion 6 of the holding element 3.

FIG. 5 shows a sectional view of a suction cup according to a development of the second exemplary embodiment that is placed on the subassembly from FIG. 2. Reference is made to FIG. 5 and FIG. 1. Following the preassembly in step S2 or following the production of the vacuum after step S4 has been completed, a retaining clip 11 is placed from above on the hollow cylindrical portion 6 of the holding element 3, holding and fixing the ultrasonic sensor 8 in the hollow cylindrical portion 6 of the holding element 3 after the suction cup 14 has been removed again. If the retaining clip is already attached before the placement of the suction cup 14, then the inner support element 17 (not shown in FIG. 5) of the suction cup can rest on the retaining clip and, in step S4, can exert pressure on the end face 18 of the ultrasonic sensor 8 via the retaining clip, or, as shown in FIG. 5, the internal support element 17 can rest directly on a central portion of the end face 18 of the ultrasonic sensor 8 and exert pressure on the latter through a, for example, circular opening in the retaining clip 11, whereas an outer circumferential edge of the end face 18 is held by the retaining clip 11.

FIG. 6 shows a suction cup 14 according to a further development of the second exemplary embodiment. The suction cup 14 of the further development is equivalent to the suction cup 14 of the second exemplary embodiment or its development and likewise has the movable cylinder 19. In addition, however, the outer wall 15 of the suction cup 14 of the development has a sliding door 22. This offers the advantage that in step S3 with the sliding door 22 opened, the suction cup 14 can be slid over the subassembly shown in FIG. 2 and having the preassembled ultrasonic sensor 8 from the side and, as a result, can be placed on this subassembly and does not need to be placed on the latter from above. Thus, the concealed mounting of the ultrasonic sensor 8 is simplified by using the proposed method even when space is restricted if, for example, the mounting is carried out in a state in which the body component 1 is already installed in a motor vehicle.

FIG. 7 shows a motor vehicle 100 having an ultrasonic sensor 8 mounted, for example, so as to be concealed behind a fender 101 (example of a body component 1 in FIG. 2) of the motor vehicle 100. The mounting has been carried out in accordance with the proposed method as claimed in one of the exemplary embodiments or its modifications. While in a visual inspection the configuration from FIG. 6 does not differ from a motor vehicle having an ultrasonic sensor mounted in a conventional way, it is to be expected that the ultrasonic sensor 8 which has been mounted in a concealed manner according to the proposed method will operate with fewer errors, supply more precise measured values and/or that during the production of a large number of motor vehicles 100 or a large number of fenders 101 with ultrasonic sensors 8 mounted concealed, the result will be a lower reject rate.

Although the present invention has been described on the basis of exemplary embodiments, it is modifiable in a variety of ways.

Both exemplary embodiments show that the ultrasonic sensor 8 is preassembled with the aid of a holding element 3 attached to the damping material 2. However, this configuration is not necessary. The holding element 3 can also be attached to the body component 1, or the ultrasonic sensor 8 can also be held in position by using a tool, not shown, which is not attached to the body component 1 or the damping material 2; in the latter case, the suction cup 14 can have a sealed lead-through for the insertion of the tool.

The sliding door 22 shown in the further development of the second exemplary embodiment can also be a hinged door or another type of door. In addition, a modification of the suction cup 14 of the first exemplary embodiment with a door is also conceivable.

In the second exemplary embodiment, further internal support elements 21 of the suction cup 14 which rest on the holding element 3 were described as a plurality of pillars 21, which press on the flange section 5 of the holding element 3 at a plurality of points. However, it is also conceivable to form a plunger (a round plunger having a hollow cylindrical central opening) instead of the plurality of pillars 21, which plunger rests substantially on the entire area of the whole of the exposed portion of the flange section 5. Accordingly, the pressure can be exerted still more uniformly on the holding element 3.

In the second exemplary embodiment, the second cylindrical portion 6 of the holding element 3 does not necessarily have to be inserted into the central opening 7 in the damping material 2 but can be formed analogously to the first exemplary embodiment and touch only a portion of the diaphragm well 10 above the sealing material 2. Conversely, in the first exemplary embodiment, the second cylindrical portion 6 of the holding element 3 can also be inserted into the central opening 7 in the damping material 2 as in the second exemplary embodiment and touch the diaphragm well 10 in its entire length projecting out of the cylindrical housing component 9.

The retaining clip 11 of the development of the second exemplary embodiment can also be used in a development of the first exemplary embodiment.

### LIST OF REFERENCE SIGNS

1 Body component
2 Damping material
3 Holding element
4 First hollow cylindrical portion
5 Flange portion
6 Second hollow cylindrical portion
7 Central opening in the damping material
8 Ultrasonic sensor
9 Cylindrical housing portion
10 Diaphragm well
11 Retaining clip
12 Ultrasonic diaphragm, end face of the diaphragm well
13 Contact pad
14 Suction cup
15 Outer wall of the suction cup
16 Suction nozzle
17 Internal support element
18 End face of the ultrasonic sensor, which is axially opposite the ultrasonic diaphragm
19 Movable cylinder
20 Hollow cylindrical opening
21 Further internal support element
22 Sliding door
100 Motor vehicle
101 Fender

1. A method for the concealed mounting of an ultrasonic sensor on a body component, comprising:
arranging a damping material having an opening on an inner side of the body component (1);
pre-assembling the ultrasonic sensor in such a way that an ultrasonic diaphragm of the ultrasonic sensor comes into flat contact with the inner side of the body component within the opening in the damping material;
placing a suction cup on the body component with the damping material arranged thereon and the ultrasonic sensor in such a way that an outer circumferential wall of the suction cup rests on the damping material and an internal support element of the suction cup rests on the ultrasonic sensor; and
producing a negative pressure in the suction cup, as a result of which the suction cup is sucked firmly against the body component and the internal support element presses the ultrasonic sensor against the body component.

2. The method as claimed in claim 1, wherein an adhesive and a sound-conducting contact pad are arranged on the ultrasonic diaphragm of the ultrasonic sensor and, in the ultrasonic sensor (8), is in flat contact with the inner side of the body component.

3. The method as claimed in claim 1, wherein when negative pressure is produced, a pressure of 150 N or more is exerted on the ultrasonic sensor.

4. The method as claimed in claim 1, wherein the suction cup has a cylinder that is movable in an axial direction which, when the suction cup is put in place, is aligned coaxially with the ultrasonic diaphragm of the ultrasonic sensor and of which an end face facing the ultrasonic sensor forms the internal support element of the suction cup, which rests on an end face of the ultrasonic sensor that is axially opposite the ultrasonic diaphragm.

5. The method as claimed in claim 1, wherein the outer circumferential wall of the suction cup has a door and, when the door is opened, the suction cup can be slid over the damping material and the preassembled ultrasonic sensor from the side and the door is then closed.

6. The method as claimed in claim 1, wherein preassembling of the ultrasonic sensor comprises:
attaching a holding element for the ultrasonic sensor to the damping material; and
inserting the ultrasonic sensor into the holding element in such a way that the ultrasonic diaphragm comes into flat contact with an inner side of the body component within the opening in the damping material.

7. The method as claimed in claim 6, wherein the suction cup has a further internal support element which, when the suction cup is put in place, rests on the holding element and presses on the holding element when the negative pressure is produced.

8. The method as claimed in claim 7, wherein the further internal support element is formed from a plurality of pillars, which rest on the holding element at a plurality of points, or the further internal support element is formed by a plunger, which rests on the entire area of the holding element.

9. The method as claimed in claim 6, wherein the ultrasonic sensor has a cylindrical housing component and a cylindrical diaphragm well inserted into an opening in an end face of the cylindrical housing component, the end face of which the cylindrical diaphragm well forms the ultrasonic diaphragm, the holding element is a hollow cylindrical holding element, which has a first hollow cylindrical portion, of which an inner contour corresponds to an outer contour of the cylindrical housing component, has a second hollow cylindrical portion, the inner contour of which corresponds to an outer contour of the cylindrical diaphragm well and the outer contour of which corresponds to an inner contour of the opening, and has a flange section, the holding element is attached to the damping material in such a way that the flange section rests on the damping material and the second hollow cylindrical portion is inserted into the opening in the damping material, the ultrasonic sensor is inserted into the holding element in such a way that the diaphragm well rests flush on the second hollow cylindrical portion of the holding element and the cylindrical housing section rests flush on the first hollow cylindrical portion of the holding element.

10. A motor vehicle having a body component on which an ultrasonic sensor is mounted in a concealed manner according to a method as claimed in claim 1.
